(19) United States
(12) Patent Application Publication
(10) Pub. No.: US 2010/0202267 A1
(43) Pub. Date: Aug. 12, 2010

(54) TRACK DETERMINATION

(75) Inventors: Chih-Yuan Chen, Changhua County (TW); Jin-Bin Yang, Changhua County (TW); Ching-Ning Chiu, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/766,096

(22) Filed: Apr. 23, 2010

Related U.S. Application Data
(63) Continuation of application No. 10/995,053, filed on Nov. 22, 2004.

(51) Int. Cl. G11B 27/36

(52) U.S. Cl. 369/53.29; G9B/27.052

(57) ABSTRACT

A light beam is scanned on a track of a recording medium, the track having a first track region and a second track region, each track region having a physical property that has recurring deviations. A wobble signal is derived from the light beam, the wobble signal having information associated with the recurring deviations. Whether the light beam is at the first track region or the second track region is determined based on a frequency, a period, or a pulse width of the wobble signal.

### CROSS REFERENCE TO RELATED APPLICATIONS

This application is a Continuation of pending U.S. patent application Ser. No. 10/995,053, filed Nov. 22, 2007, the entirety of which is incorporated by reference herein

### BACKGROUND

This description relates to track determination.

FIG. 1 shows an example of an optical recording system 10 for recording data to and reading data from an optical disc 12. The recording system 10 includes a disc drive controller 14 that controls a spindle motor 16 and a sled motor 18. The spindle motor 16 controls the rotation speed of the optical disc 12, and the sled motor 18 controls the position of an optical pickup head 20 relative to the disc 12. The pickup head 20 includes a laser diode that generates a laser beam 22 whose power is adjusted by the controller 14 during read and write operations. The controller 14 includes circuitry for encoding signals written to the disc 12, circuitry for decoding signals retrieved from the disc 12, and circuitry for interfacing with a host computer.

FIG. 2 shows an example of the optical disc 12 that includes a servo track 30, which forms a spiral groove on the disc 12. The servo track 30 guides the pickup head 20 during write operations, in which the pickup head 20 modifies the reflectivities of portions of the groove, and during read operations, in which the pickup head 20 detects reflectivity differences in the groove. The servo track 30 has a pre-recorded region 32 and a rewritable region 34. The pre-recorded region 32 is pre-recorded with control information (such as the type of the disc, the length of the writable region, and the recommended recording and erasing powers).

The rewritable region 34 allows a user to write user data. When binary bits of data are recorded in the rewritable region 34, the data bits of a recording frame (other than a frame synchronization portion) are converted to modulation bits using 17 PP modulation codes, and further converted to non-return-to-zero inverted (NRZI) channel bits through a non-return-to-zero (NRZ) conversion. 17 PP is an abbreviation of (1,7) run length limited parity-preserve prohibit repeated minimum transition runlength. Each channel bit has a predefined time length T. A channel bit value 1 is represented by a change in reflectivity in the groove within a time T, and a channel bit value 0 is represented by no change in reflectivity within a time T.

FIG. 3 depicts the irradiation of a laser beam 22 on the servo track 30. The servo track 30 includes a groove 36 that is located nearer to the entrance surface (the surface of the disc on which the laser beam first impinges) than adjacent areas 38, referred to as lands. The groove 36 and the land 38 have different reflectivities, thus different areas of the cross section of the laser beam 22 will be reflected differently.

As shown in FIG. 4, the servo track 30 has recurring deviations in a radial direction 40 along the length of the track, referred to as track wobble. In one example, the wobble in the rewritable region 34 is modulated to contain address information, referred to as the address in pre-groove (ADIP). The wobble in the pre-recorded region 32 is modulated to contain the control information.

U.S. published application 2003/0090977 describes an optical disc that has a servo track having a wobble that is modulated to include address information using minimum shift keying modulation. The servo track also has a management area in which the servo track is modulated to include management data by using a direct digital modulation. U.S. published application 2004/0125731 describes the use of high frequency modulated (HFM) grooves that are modulated to store permanent information and control data using bi-phase modulation.

A time varying signal, referred to as the wobble signal, that is derived from the reflected laser beam 22 has variations in accordance with the track wobble. The wobble signal can be used to maintain the pickup head 20 to move along an average center line 42 of the servo track 30, control the rotation speed of the disc 12, and synchronize a write clock of the recording system 10. The wobble signal can be demodulated to retrieve the address information, which is used by the recording system 10 to determine the position of the pickup head 20 relative to a starting position of the servo track 30.

In the description below, depending on context, the term “track wobble” can refer to the track deviations in the pre-recorded region 32 or the wobble in the rewritable region 34. Depending on context, the term “wobble signal” can refer to the time varying signal derived from the reflected laser beam 22 when the pickup head 20 is at the pre-recorded region 32 or at the rewritable region 34.

In one example, the radial distance of the pre-recorded region 32 from a center 44 of a center hole 46 of the disc 12 is less than a predetermined value r, whereas the radial distance of the rewritable region 34 from the center 44 is greater than r. In one example, the recording system 10 can selectively position the pickup head 20 at pre-recorded region 32 or the rewritable region 34 by moving the pickup head 20 to specified radial distances smaller or greater than r, respectively.

### SUMMARY

In one aspect, the invention features a method that includes scanning a light beam on a track of a recording medium, the track having a first track region and a second track region, each track region having a physical property that has recurring deviations, deriving a wobble signal from the light beam, the wobble signal having information associated with the recurring deviations, and determining whether the light beam is at the first track region or the second track region based a frequency, a period, or a pulse width of the wobble signal.

Implementations of the invention may include one or more of the following features. The method includes determining a statistical measure of at least one of the frequency, the period, and the pulse width of the wobble signal. The statistical measure includes at least one of a maximum value, a minimum value, an average value, a standard deviation, and a distribution. Determining whether the light beam is at the first track region or the second track region is based on the statistical measure. The wobble signal has a first average frequency when the light beam scans the first track region, and the wobble signal has a second average frequency when the light beam scans the second track region. The recurring deviations in the first track region are modulated according to a first type of modulation, and the recurring deviations in the second track region are modulated according to a second type of modulation. The first track region stores address information. The second track region stores control information related to reading data from or writing data to the recording medium. The first type of modulation includes a frequency modulation or a phase modulation. The phase modulation includes a minimum shift keying modulation. The second type of modulation includes a direct modulation of the track, where logical values of bits are represented by displacements of the track. The recurring deviations of the physical parameter include deviations of the track borders.

In another aspect, the invention features a method that includes rotating a disc that includes a track having a physical parameter that has recurring deviations, moving a detector relative to the disc, generating a wobble signal based on detected variations in the physical parameter, adjusting a rotation speed of the disc relative to the detector based on at least one of a frequency, a period, and a pulse width of the wobble signal, and determining a track location of the detector based on the rotation speed of the disc.

Implementations of the invention may include one or more of the following features. The method includes determining at least one of a maximum value, a minimum value, and an average value of at least one of the frequency, the period, and the pulse width of the wobble signal. The track includes a first track region and a second region, the recurring deviations in the first track region being modulated according to a first type of modulation, the recurring deviations in the second track region being modulated according to a second type of modulation. The first track region stores pre-recorded data. The second track region allows a user to store data.

In another aspect, the invention features a method that includes receiving a recording medium that includes a track having a first track region and a second track region, moving a detector to a first position to detect variations of the track in the first track region, measuring at least one of a frequency, a period, and a pulse width of the variations to generate a first set of measured value or values, moving the detector to a second position to detect variations of the track, measuring at least one of a frequency, a period, and a pulse width of the variations to generate a second set of measured value or values, and comparing the first set of measured value or values and the second set of measured value or values to determine whether the detector is at the second track region.

Implementations of the invention may include one or more of the following features. The first track region includes a rewritable region that allows a user to write data, and the second track region includes a pre-recorded region that stores pre-recorded data. The variations in the first track region are modulated according to a first type of modulation, and the variations in the second track region are modulated according to a second type of modulation.

In another aspect, the invention features a method that includes deriving a wobble signal from a beam that is scanned on a track of a recording medium, the track having a first track region and a second track region, each track region having a physical property that has recurring deviations, the wobble signal having information associated with the recurring deviations; and determining whether the beam is at the first track region or the second track region based on a time-dependent characteristic of the wobble signal.

Implementations of the invention may include one or more of the following features. The time-dependent characteristic includes at least one of a frequency, a period, and a pulse width. The recording medium includes a disc, the first track region occupies a first portion of the disc having a radius smaller than a specified value, and the second track region occupies a second portion of the disc having a radius larger than or equal to the specified value.

In another aspect, the invention features an apparatus that includes a circuit to determine a position of a detector relative to a track of a recording medium based on at least one of a frequency, a period, and a pulse width of a wobble signal that contains information about recurring deviations of a physical parameter of the track.

Implementations of the invention may include one or more of the following features. The recurring deviations of the physical parameter include recurring deviations of borders of the track in a radial direction. The apparatus includes a memory to store values associated with at least one of a frequency, a period, and a pulse width of the wobble signal. The circuit measures at least one of a frequency, a period, and a pulse width of the wobble signal, and compares the measured values with the stored values to determine the position of the detector. The apparatus includes a memory that stores values associated with a statistical measure of at least one of a frequency, a period, and a pulse width of the wobble signal. The statistical measure includes determining at least one of a maximum, a minimum, an average, a standard deviation, and a distribution. The circuit measures a statistical value of at least one of the frequency, the period, and the pulse width of the wobble signal, and compares the measured values with the stored values to determine the position of the detector.

The apparatus includes the detector to detect the recurring deviations. The apparatus includes a wobble signal generator to generate the wobble signal based on detected recurring deviations. The apparatus includes a controller to control a rotation speed of the recording medium relative to the detector. The controller controls the rotation speed of the recording medium so that the detector moves relative to the track at a substantially constant linear velocity when the wobble signal is generated. The controller controls the rotation speed of the recording medium so that the recording medium rotates at a substantially constant angular velocity when the wobble signal is generated. The apparatus includes a motor to move the detector relative to the recording medium.

In another aspect, the invention features an apparatus that includes a module to determine whether a detector is at a first track region or a second track region of a track of a recording medium based on a rotation speed of the recording medium, the first track region having a physical parameter that has recurring deviations that are modulated according to a first type of modulation, the second track region having a physical parameter that has recurring deviations that are modulated according to a second type of modulation.

Implementations of the invention may include one or more of the following features. The first type of modulation includes a phase or frequency modulation, and the second type of modulation includes a direct modulation of the track in which logical values of bits are represented by displacements of the track. The module includes a controller that controls the rotation speed of the recording medium based on at least one of a frequency, a period, and a pulse width of the wobble signal. The controller controls the rotation speed based on at least one of a maximum, a minimum, an average, a standard deviation, or a distribution of at least one of the frequency, the period, and the pulse width.

In another aspect, the invention features an optical recording system for recording data on a recording medium having a track that includes a first track region and a second track region, each track region having a physical parameter that has recurring deviations, the system includes a detector to detect the recurring deviations, a wobble signal generator to generate a wobble signal based on detected recurring deviations, a circuit to determine whether the detector is at the first track region or the second track region based on at least one of a frequency, a period, and a pulse width of the wobble signal, and an actuator to move the detector based on the determination of whether the detector is at the first track region or the second track region.

Implementations of the invention may include one or more of the following features. The apparatus includes a memory to store at least one of a predetermined maximum value, a predetermined minimum value, a predetermined average value, a predetermined standard deviation value, and a predetermined distribution of at least one of a frequency, a period, and a pulse width of the wobble signal. The circuit measures at least one of a maximum value, a minimum value, an average value, a standard deviation, and a distribution of at least one of the frequency, the period, the half-period, and the pulse width of the wobble signal, and compares the measured value or values with at least one of the predetermined values stored in the memory.

In another aspect, the invention features an apparatus that includes means for scanning a light beam on a track of a recoding medium, the track having a first track region and a second track region, each track region having a physical parameter that has recurring deviations, means for deriving a wobble signal from the light beam, the wobble signal containing information about the recurring deviations, and means for determining whether the light beam is at the first track region or the second track region based on at least one of a frequency, a period, and a pulse width of the wobble signal.

Implementations of the invention may include one or more of the following features. The determining means determines whether the light beam is at the first track region or the second track region based on at least one of a maximum value, a minimum value, an average value, a standard deviation, and a distribution of at least one of the frequency, the period, and the pulse width of the wobble signal.

In another aspect, the invention features an apparatus that includes a circuit to determine a position of a detector relative to a track of a recording medium based on at least a time-dependent characteristic of a wobble signal that contains information about recurring deviations of a physical parameter of the track.

Implementations of the invention may include one or more of the following features. The time-dependent characteristic comprises at least one of a frequency, a period, and a pulse width. The apparatus includes a memory to store a statistical measure of the time-dependent characteristic of the wobble signal.

### DESCRIPTION OF DRAWINGS

FIG. 1 shows an optical recording system.

FIG. 2 shows an optical disc.

FIG. 3 shows a cross section of a laser beam and a servo track.

FIG. 4 shows the servo track of FIG. 2.

FIG. 5 shows a rewritable region.

FIG. 6 shows a pre-recorded region.

FIG. 7 shows a synchronization pattern.

FIG. 8 shows a wobble signal generator and units for processing the wobble signal.

FIG. 9 shows a push-pull signal.

FIG. 10 shows a chart that includes track wobble frequencies and periods.

FIGS. 11 and 12 show processes for moving a pickup head.

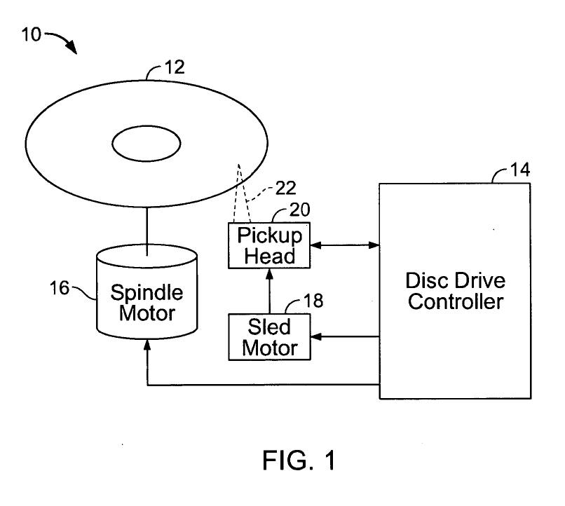

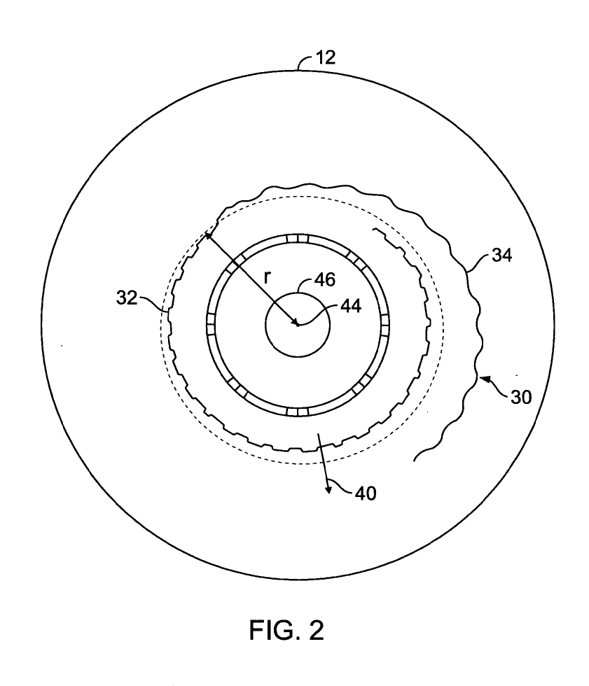

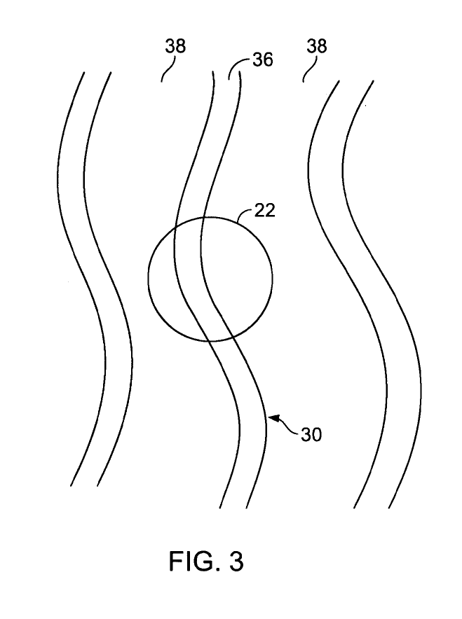

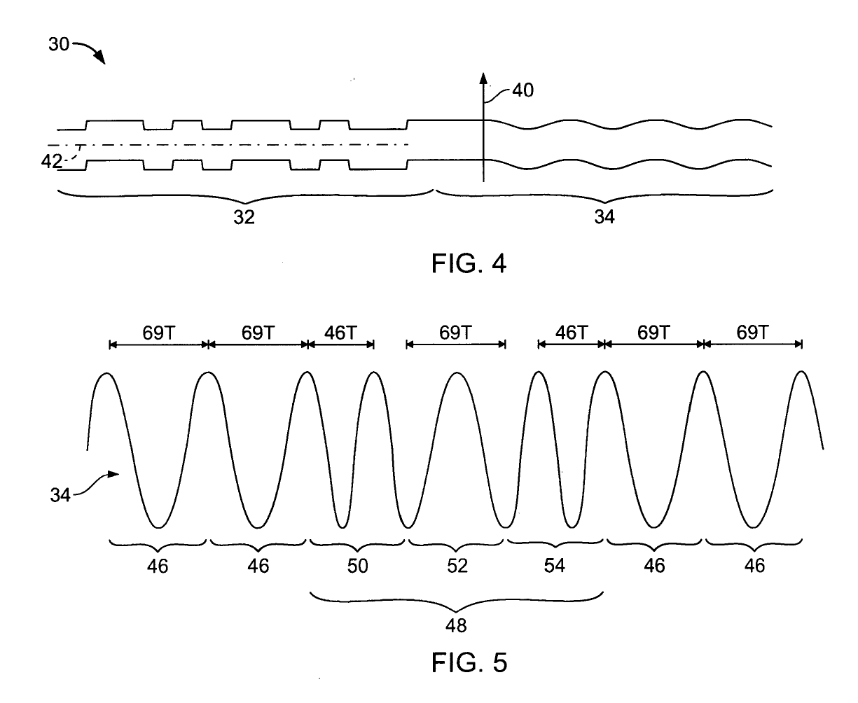

### DESCRIPTION

A recording system 10 can selectively position a pickup head 20 at a pre-recorded region 32 or a rewritable region 34 of a disc 12 based on characteristics, such as the frequency, period, or pulse width of the wobble signal. The pre-recorded region 32 and the rewritable region 34 have track wobbles that are modulated according to different types of modulation. Depending on whether the pickup head 20 is at the pre-recorded region 32 or the rewritable region 34, the characteristics of the wobble signal will be different.

Because the pre-recorded region 32 and the rewritable region 34 record data use different modulation methods, it is useful to determine whether the pickup head 20 is located at the pre-recorded region 32 or the rewritable region 34 before attempting to read data from or write data to the disc 12. In one example, the optical disc 12 is a Blu-ray Disc, available from Sony Corporation, Tokyo, Japan.

FIG. 5 shows an example of the track wobble in the rewritable region 34, which includes monotone wobbles 46 and minimum shift keying (MSK) marks 48. Each monotone wobble has a shape that can be represented by a cosine function: cos(2.pi.times.f.sub.wob.times.t), where f.sub.wob represents the frequency of the track wobble (referred to as the “wobble frequency”), and t represents time. In one example, the period of each monotone wobble is 69 T, and the half-period is 34.5 T, where T corresponds to the length of a channel bit. The frequency and period can be measured from the signals output by the pickup head 20.

In general, the term “half-period” refers to a time duration in which the signal either is high or low, and the term “period” refers to a time duration that includes one high interval and one low interval.

A minimum shift keying mark 48 includes three segments 50, 52, and 54. The first and third segments, 50 and 54, each has a cosine wobble with a frequency 1.5.times.f.sub.wob, and the second segment 52 has a cosine wobble with a frequency f.sub.wob. In one example, in the first and third segments 50 and 54, the period of the wobble is 46 T (and the half-period is 23 T). In the second segment 52, the period of the wobble is 69 T. In one example, the average period of the track wobble in the rewritable region 34 is 66.8 T, so that the average half-period is 33.4 T.

Referring to FIG. 6, in one example, the pre-recorded region 32 includes a high frequency modulated (HFM) groove 60 in which the track wobble is bi-phase modulated. The HFM groove 60 stores data, referred to as permanent information and control (PIC) data, with synchronization patterns placed in between frames of the PIC data. The portions of the pre-recorded region 32 that store PIC data are divided into bit cells 62, each bit cell 62 storing one bit of data and having, e.g., a length of 36 T. A centerline 64 of the HFM groove 60 deviates from an average centerline 66 according to a bi-phase modulation. A bit value 0 is represented by a transition at the start (e.g., 68) of a bit cell 62, and no transition until the start of the next bit cell. A bit value 1 is represented by a transition at the start and near the middle (e.g., 70) of a bit cell 62. In one example, in the portions of the pre-recorded region 32 storing the PIC data, the half-periods are either 18 T or 36 T, and the average half period is about 24.3 T.

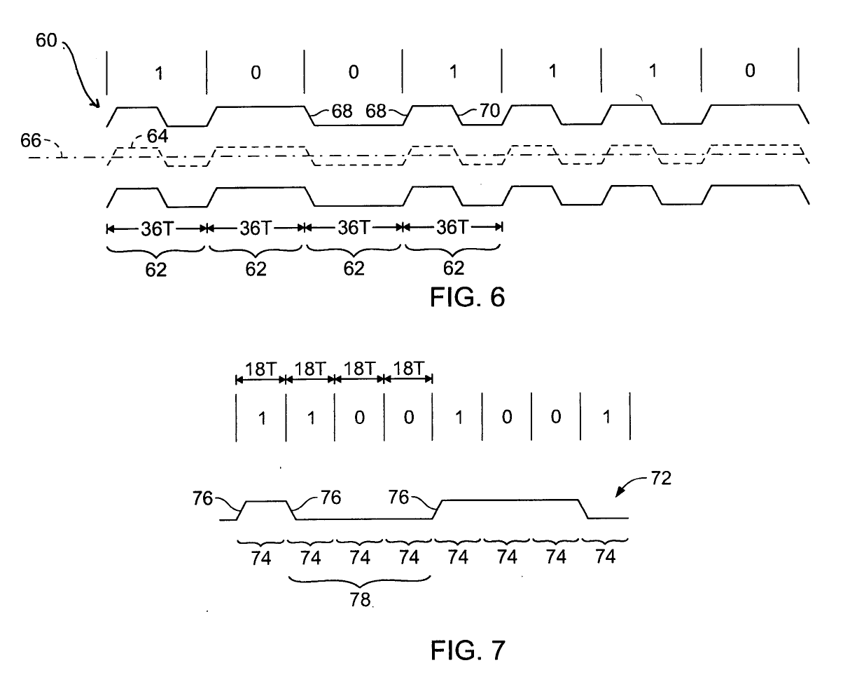

Referring to FIG. 7, an example of a synchronization pattern 72 that includes eight bit cells 74, each bit cell 74 storing one bit of information and has a length 1 T. In the synchronization pattern 72, a bit value 1 is represented by a transition (e.g., 76) at the beginning of a bit cell 74, and a bit value 0 is represented by no transition. The longest half-period of the track wobble in the pre-recorded region 32 occurs in the synchronization pattern 72, such as 78, which has three bit cells 74 and has a half-period of 54 T.

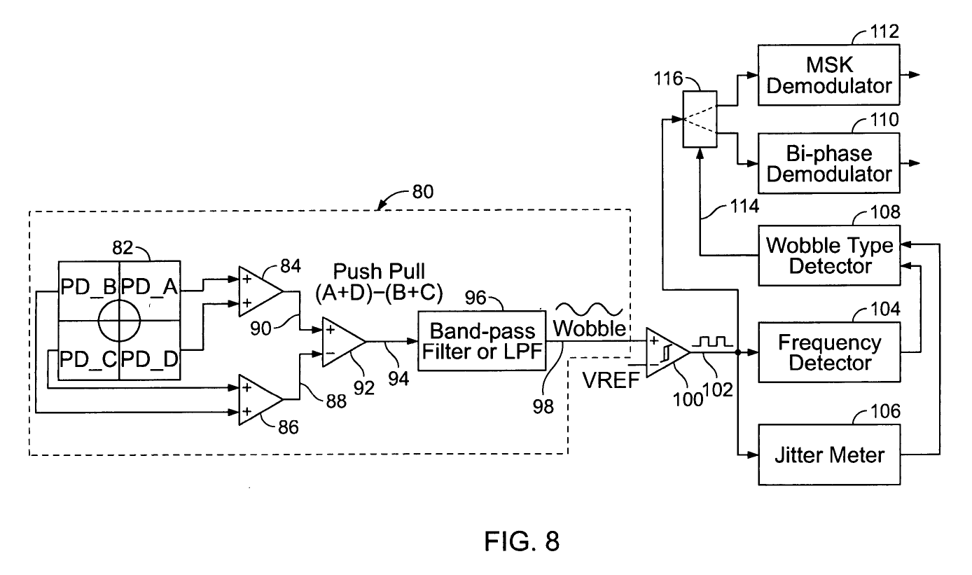

Referring to FIG. 8, a wobble signal generator 80 includes a quad-section photo detector 82 that has four photo detectors PD_A, PD_B, PD_C, and PD_D for detecting the laser beam 22, and their outputs are represented as A, B, C, and D, respectively. The outputs of photo detectors PD_A and PD_D are added by an adder 84, and the outputs of photo detectors PD_B and PD_C are added by an adder 86. An output 88 of the adder 86 is subtracted from an output 90 of the adder 84 by a subtractor 92, which generates a push-pull signal 94 having a value (A+D)−(B+C). The push pull signal 94 passes through a band-pass filter (or low pass filter) 96, generating a wobble signal 98. The wobble signal 98 represents a filtered push-pull signal. A comparator 100 compares the wobble signal 98 with a reference voltage V.sub.REF and generates a pulse signal 102. The pulse signal 102 is forwarded to a frequency detector 104 and a jitter meter 106 to determine the frequency and period, respectively, of the pulse signal 102. In the description below, the term “wobble frequency” will be used to refer to the frequency of the pulse signal 102.

The frequency and period values are sent to a wobble type detector 108 to determine the wobble type at the current pickup head location. Depending on whether the pickup head 20 is at an HFM groove or a wobble groove, the pulse signal 102 is sent to a bi-phase demodulator 110 or an MSK demodulator 112, respectively, to retrieve data contained in the track wobble. The wobble type detector 108 generates a selection signal 114 to control a switch 116 for determining whether the pulse signal 102 is processed by the demodulator 110 or 112.

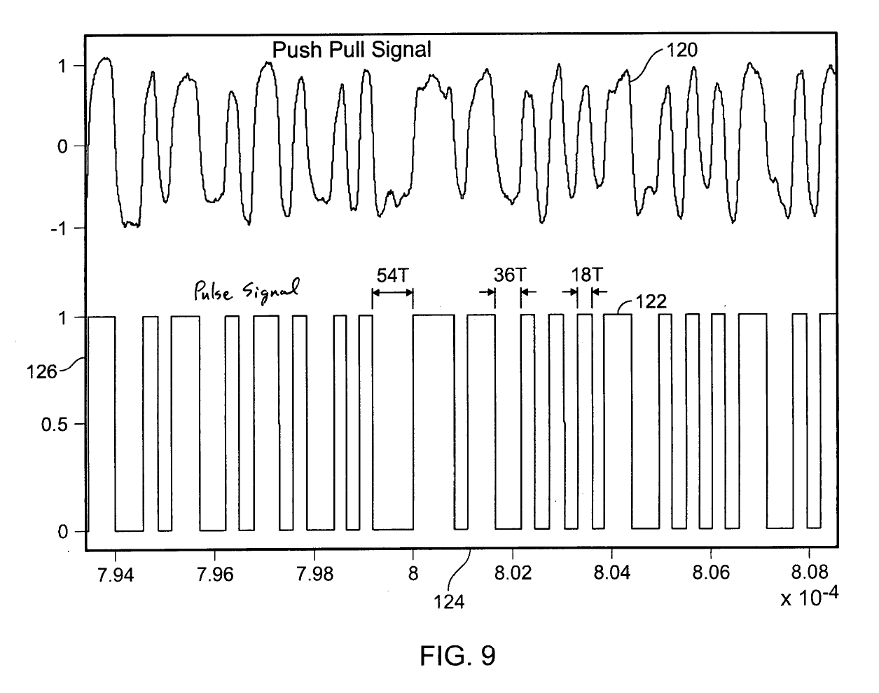

FIG. 9 shows an example of a push-pull signal 120 that is generated when the pickup head 20 is at the pre-recorded region 32, where the track wobble is bi-phase modulated. A pulse signal 122 is derived from the push-pull signal 120. The horizontal axis 124 represents time, and the vertical axis 126 represents the amplitude of the signal. The pulse signal 122 has pulse widths having values 18 T, 36 T, and 54 T. The pulse widths of the pulse signal 122 correspond to the half-periods of the push-pull signal 120.

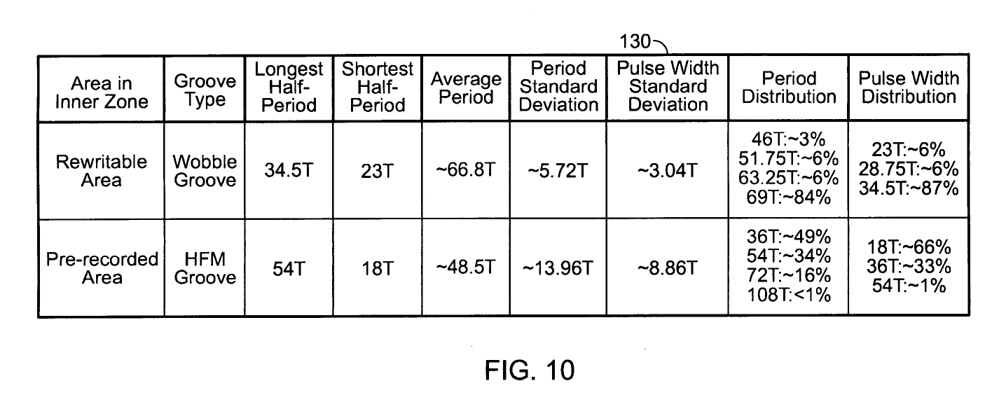

Referring to FIG. 10, a chart 130 shows a comparison of the track wobble frequencies and periods for the two types of grooves in the pre-recorded region 32 and rewritable region 34 when certain encoding schemes are used. In the description below, the groove in the pre-recorded region 32 will be referred to as the HFM groove, and the groove in the rewritable region 34 will be referred to as the wobble groove.

In the wobble groove, the longest half-period is 34.5 T, whereas in the HFM groove, the longest half-period is 54 T. In the wobble groove, the shortest half-period is 23 T, whereas in the HFM groove, the shortest half-period is 18 T. In the wobble groove, the average period is about 66.8 T, whereas in the HFM groove, the average period is about 48.5 T. In the wobble groove, the standard deviation of the period length is about 5.72 T, whereas in the HFM groove, the standard deviation is about 13.96 T. In the wobble groove, the standard deviation of the pulse width is about 3.04 T, whereas in the HFM groove, the standard deviation is about 8.86 T.

Both in the wobble groove and the HFM groove, the period length can have several values. In the wobble groove, about 3% of the period is 46 T, about 6% is 51.75 T, about 6% is 63.25 T, and about 84% is 69 T. By comparison, in the HFM groove, about 49% of the period is 36 T, about 34% is 54 T, about 16% is 72 T, and less than 1% is 108 T.

Both in the wobble groove and the HFM groove, the pulse width can have several values. In the wobble groove, about 6% of the pulse width is 23 T, about 6% is 28.75 T, and about 87% is 34.5 T. By comparison, in the HFM groove, about 66% of the pulse width is 18 T, about 33% is 36 T, and about 1% is 54 T. The above values can be obtained by measuring the signal 98 or the pulse signal 102 (FIG. 8) for a known disc 12.

In one example, when the recording system 10 operates under a constant linear velocity mode, and the disc is rotated at 1.times. speed, the channel code has a bit rate of 66 MHz. The monotone wobble 46 in the rewritable region 34 has a period equal to 69 T, and thus has a frequency equal to 956.52 KHz. When the pickup head 20 is at the HFM groove, the linear velocity of the pickup head 20 relative to the rotating disc 12 is about 5.28 meter/second, and the disc rotates at about 37.8 Hz (revolutions per second).

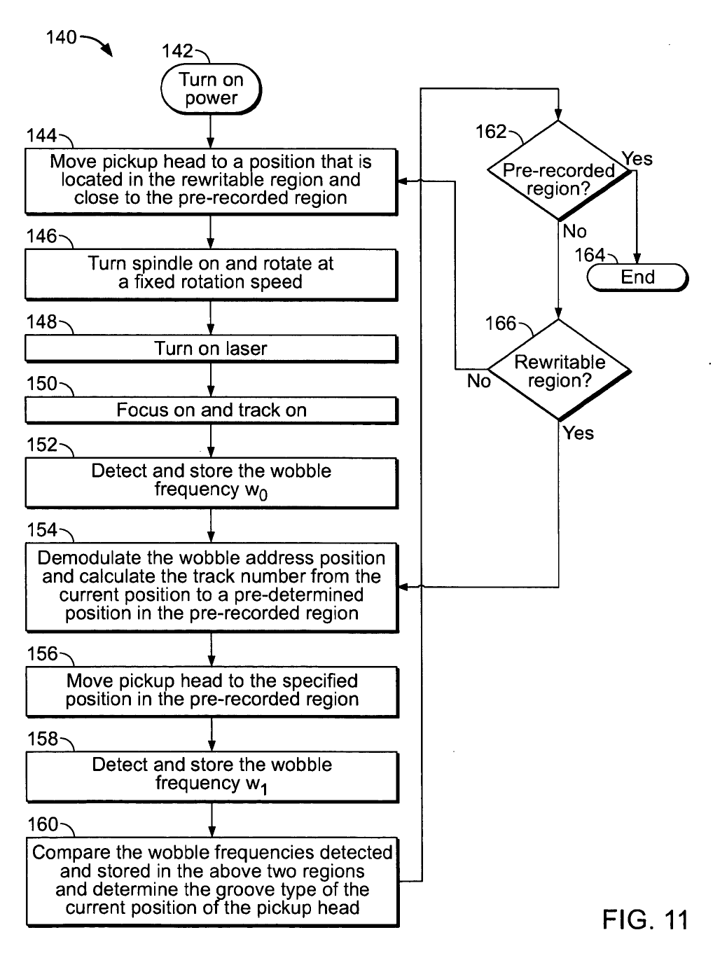

Referring to FIG. 11, the recording system 10 uses a process 140 to move the optical pickup head 20 to a location in the pre-recorded region 32. After the power of the optical recording system 10 is turned on (142), the pickup head 20 is moved (144) to a position that is near 24 mm from the center 44 of the center hole 46 of the disc 12. This position would place the pickup head 20 in the rewritable region 34, at a location that is close to the pre-recorded region 32. The spindle motor 16 of the recording system 10 is turned on (146) and rotated at a fixed rotation speed (e.g., 37.8 Hz). The laser of the pickup head 20 is turned on (148). The position of the pickup head 20 is adjusted to focus the laser beam 22 on the groove of the servo track 30. The pickup head 20 starts tracking (150) the servo track 30. A pulse signal 102 is generated from the reflected laser beam 22 using the wobble signal generator 80 and the comparator 100 (FIG. 8). The average wobble frequency w0 of the pulse signal 102 is detected and stored (152) in a memory. The average wobble frequency represents an average of the frequency of track wobble measured over a predetermined period of time.

The pulse signal 102 is demodulated (154) by the MSK demodulator 112 to obtain address information. The track number between the current position to a specified position in the pre-recorded region 32 is calculated. Based on the calculated track number, the pickup head 20 is moved (156) to the specified position in the pre-recorded 32. The average wobble frequency w1 is detected and stored (158) in the memory.

The wobble frequencies w0 and w1 are compared (160) with pre-stored threshold values, such as those shown in the chart 130 of FIG. 10, to determine (162) whether the pickup head 20 is at the pre-recorded region 32. For example, for a Blu-ray disc rotating at 1.times. speed, the channel bit frequency is 66 MHz, and the average period of the HFM groove is about 48.5 T, so the average frequency of the HFM groove is larger than 1.36 MHz. If the average frequency of the pulse signal 102 is greater 1.3 MHz, the system determines that the pickup head 20 is at the HFM groove of the pre-recorded region 32, and the process 140 ends (164).

If the pickup head 20 is not at the pre-recorded region 32, the wobble frequency w1 is compared with pre-stored threshold values, such as those shown in the chart 130, to determine (166) whether the pickup head 20 is at the rewritable region 34. For example, when the channel bit frequency is 66 MHz, and the average period of the wobble groove is about 66.8 T, the average wobble frequency is about 988 KHz. If the wobble frequency w1 is less than 1 MHz, then the recording system 10 determines that the pickup head 20 is at the rewritable region 34. If the system 10 determines 166 that the pickup head 20 is not at the rewritable region 34, the process 140 jumps to step 144 to reposition the pickup head 20 in the rewritable region 34. If the pickup head 20 is at the rewritable region 34, the process 140 jumps to step 154 to determine the address information and re-attempt to position the pickup head 20 at the pre-recorded region 32.

In an alternative example, in step 160, instead of comparing the wobble frequency with pre-stored values, the wobble frequencies w0 and w1 stored in steps 152 and 158 are compared with each other. For example, if the difference between w0 and w1 is less than a tolerance value, the system 10 determines that the pickup head 20 is at the rewritable region 34 at steps 162 and 166. If the difference between the average wobble frequencies w0 and w1 is larger than a tolerance value, the system 10 determines that the pickup head 20 is at the pre-recorded region 32. The system 10 confirms that the pickup head 20 is at the pre-recorded region 32 by using specified criteria. For example, w1 should be larger than w0. If not, there may be an error, and the process 140 jumps to step 144 and starts over.

In yet another example, the pickup head 20 is initially moved to near the center 14, then moved radially outwards of about 22 mm, which places the pickup head 20 at the pre-recorded region 32. To reduce errors due to tolerances in the disc 12 and the sled motor 18, the frequencies of the pulse signal 102 are compared with pre-stored values to determine whether the pickup head 20 is actually positioned at the pre-recorded region 32.

In process 140, the average frequency of the pulse signal 102 is compared with pre-stored values to determine whether the pickup head 20 is located at the pre-recorded region 32 or the rewritable region 34. Other parameters, such as the longest half-period, the shortest half-period, the standard deviation of the period, the standard deviation of the pulse width, or any combination thereof, can also be used. These parameters can be determined based on measurements made over a predetermined time period or a predetermined track length.

Instead of using the pulse signal 102, the wobble signal 98 can also be compared with pre-stored values to determine whether the pickup head 20 is located at the pre-recorded region 32 or the rewritable region 34. Other signals derived from the wobble signal 98 or pulse signal 102 can also be compared with pre-stored values to determine whether the pickup head 20 is located at the pre-recorded region 32 or the rewritable region 34.

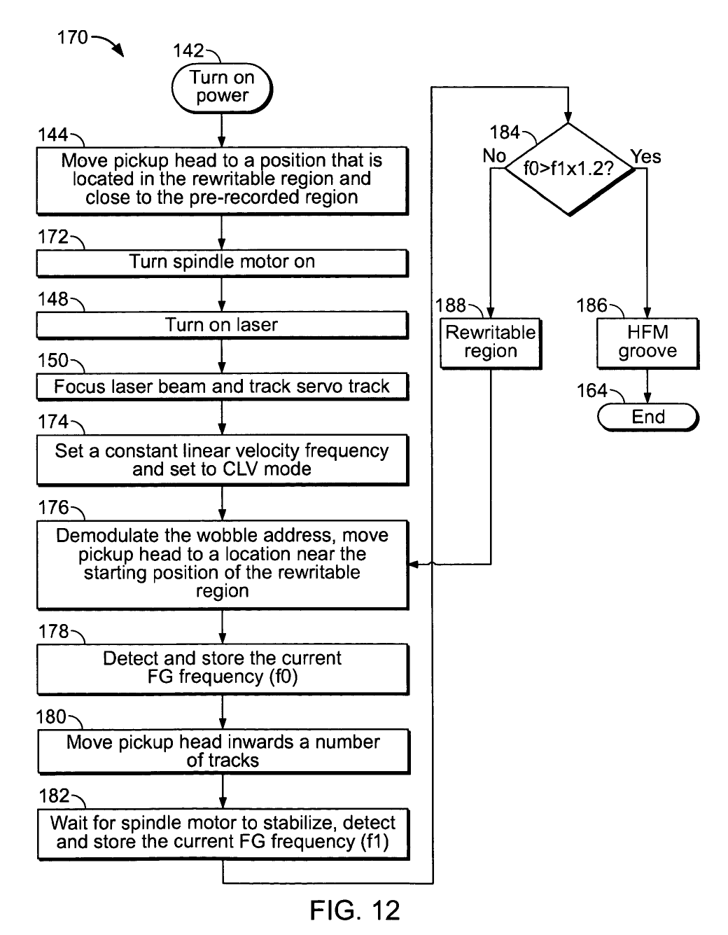

Referring to FIG. 12, in an alternative example, the recording system 10 uses a process 170 to move the optical pickup head 20 to a location in the pre-recorded region 32 by measuring the rotation speed of disc 12 (which is the same as the rotation speed of the spindle motor 16), rather than measuring the wobble frequency.

The power of the optical recording system 10 is turned on (142), and the pickup head 20 is moved (144) to a position that is near 24 mm from the center 44. This position would place the pickup head 20 in the rewritable region 34. The spindle motor 16 is turned on (172). The laser of the pickup head 20 is turned on (148). The pickup head 20 focuses the laser beam 22 and tracks (150) the servo track 30. A pulse signal is generated from the reflected laser beam 22 using the wobble signal generator 80 and the comparator 100 (FIG. 8).

A particular wobble frequency is selected (174), and the recording system 10 is set to the constant linear velocity mode. The spindle motor 16 rotates the disc 12 to maintain the wobble frequency at the specified value. In one example, when the recording system 10 is operating under constant linear velocity mode at 1.times. speed, the channel bit frequency is 66 MHz, the average wobble period is 66.8 T, and the average wobble frequency is 988 KHz. In step 174, the wobble frequency can be set at 988 KHz.

The wobble signal is demodulated (176) to obtain the address information. The track number between the current position to the starting position of the rewritable region 34 is calculated. Based on the calculated track number, the pickup head 20 is moved to a location near the starting position of the rewritable region 34. The rotation frequency of the disc 12, represented by an FG frequency value, f0, is detected and stored (178) in the memory. In one example, when the pickup head 20 is near the beginning of the rewritable region 34, the disc rotation speed is about 36.2 revolutions per second. Thus, f0 is approximately equal to 36.2 Hz.

The pickup head 20 is moved (180) inwards towards the center 44 a number of tracks. The recording system 10 adjusts the spindle motor 16 so that the wobble frequency is maintained at 988 KHz. The recording system 10 waits until the spindle motor 16 stabilizes, then detects and stores (182) the current FG frequency value, f1. Because the average wobble period of the HFM groove is about 48.5 T (whereas the average period of the wobble signal in the rewritable region 34 is 66.8 T), the spindle motor 16 would have to decrease the rotation speed, such that f0=f1.times.n, where n=66.8/48.5=1.377, in order to maintain the wobble frequency at 988 KHz.

The value f0 is compared (244) with the value 1.2.times.f1. If f0 is not greater than 1.2.times.f1, the system 10 determines (188) that the pickup head 20 is still at the rewritable region 34, and jumps to step 176. If f0 is larger than 1.2.times.f1, the system 10 determines (186) that the pickup head 20 is at the pre-recorded region 32, and ends (164) the process 170. After the system 10 determines that the pickup head 20 is at the pre-recorded region 32, the system 10 demodulates the signal read from the pickup head 20 using the bi-phase demodulator 110.

An advantage of using the process 140 or 170 is that the recording system 10 can quickly position the pickup head 20 at the pre-recorded region 32 upon startup of the recording system 10, and quickly read the permanent information and control data stored at the pre-recorded region 32. An advantage of comparing characteristics of the signal 98 or pulse signal 102 with pre-stored values, such as those in the chart 130, is that the system 10 can more accurately determine whether the pickup head 20 is at the pre-recorded region 32 or the rewritable region 34.

Without using process 140 or 170, the recording system 10 would have to initially determine whether the pickup head 20 is at the pre-recorded region 32 or rewritable region 34 based on the radial distance of the pickup head 20 from the center 44, try to decode the data read by the pickup head 20 based on the initial determination, and if the system 10 cannot decode the data, switch to another decoding method to decode the data read by the pickup head 20. Such trial-and-error method requires a longer time than processes 140 and 170. When the process 140 or 170 is used, the system 10 does not have to wait for the pickup head 20 to be stably locked on to a particular track (which would be required to read data from the disc 12) to determine whether the pickup head is at the pre-recorded region 32 or the rewritable region 34.

Although some examples have been discussed above, other implementations and applications are also within the scope of the following claims. For example, the optical disc 12 can be a write-once disc such that the servo track includes a writable region (which allows the user to write data once) instead of a rewritable region. The optical disc 12 can be compatible with various standards, and can have wobble frequencies, periods, pulse widths that are different from what was mentioned above. The disc drive controller 14 can be designed to process signals that are encoded differently.

The characteristics of the pre-recorded region 32 and the rewritable region 34 may be different from what is shown in the chart 130 of FIG. 10. For example, the values for the longest half-period, the shortest half-period, the average period, the standard deviation of the periods, the standard deviation of the pulse widths, the distribution of periods, and the distribution of pulse widths can be different.

The servo track 30 can have more than two regions having different types of track wobbles. Each type of track wobble can have particular characteristics. Each of the different regions can be distinguished based on the values of the longest half-period, the shortest half-period, the average period, the standard deviation of the periods, the standard deviation of the pulse widths, the distribution of periods, and the distribution of pulse widths, and so forth.

The servo track 30 can include a land portion that has track wobbles, instead of a groove portion having track wobbles. The optical disc 12 can have two servo tracks, one servo tracking including a land portion, the other servo track including a groove portion. The servo track does not necessarily have to be a spiral on a circular disc. The servo track can be disposed on a long tape, and the pickup head scans the servo track as the tape moves forward or backward relative to the pickup head.

The optical disc 12 can have more than one reflective layer. The disc can be designed so that the pickup head 20 can read and write information from the multiple layers from the same side of the disc. The disc can also be designed so that the at least one pickup head is located at each side of the disc. When there are two layers on a disc, a servo track on one layer may start at a position close to the inner portion of the disc and spiral outwards, and a servo track on the other layer may start at a position close to the outer portion of the disc and spiral inwards.

Using characteristics of the wobble signal to determine the location of the pickup head relative to a servo track is not limited to optical recording systems, and can be used in other systems, such as magneto-optic or magnetic recording systems.

The HFM groove can be modulated using different methods. For example, a logical value 1 can be represented as a track deviation to the left, and a logical value 0 can be represented as a track deviation to the right (relative to the scanning direction of the pickup head). The wobble groove can be frequency modulated, such that logical values of 0 and 1 are represented by different frequencies. The wobble groove can store an encoded format of the address information, such as Gray codes that represent address information. The wobble groove may store track number information in additional to the address information.

What is claimed is:

1. A method for determining a position of an optical pick-up head emitting light on an optical disc in an optical disc drive, the optical disc comprising a pre-recorded region and a rewritable region, the method comprising:
detecting at least two wobble signals when the optical disc is rotated at a same speed;
obtaining a first parameter related to a first wobble signal and a second parameter related to a second wobble signal;
comparing the first parameter and the second parameter with a first pre-stored threshold value and a second pre-stored threshold value;
if the first parameter is larger than the first pre-stored threshold value, then it is determined that the light beam is at the pre-recorded region; and
if the first parameter is smaller than the first pre-stored threshold value and the second parameter is smaller than the second pre-stored threshold value, then it is determined that the light beam is at the rewritable region.

2. The method of claim 1, wherein the first pre-stored threshold value is larger than the second pre-stored threshold value.

3. The method of claim 1 wherein the pre-recorded region comprises a frequency modulation or a phase modulation.

4. The method of claim 1 wherein the rewritable region comprises a minimum shift keying modulation.

5. The method of claim 1 wherein the first parameter and the second parameter can be frequency, period, or pulse width of the wobble signal.

6. The method of claim 5, wherein the frequency, period or pulse width of the wobble signal are averages of the frequency, period or pulse width of the wobble signal measured over a predetermined period of time.

7. The method of claim 1 wherein the first parameter and the second parameter are detected at different locations of the track.

8. The method of claim 1 wherein the first pre-stored threshold value and the second pre-stored threshold value are stored in memory.

9. The method of claim 1 wherein when the optical disk rotates at 1× speed, the first pre-recorded threshold value is substantially 1.3 MHz, and the second pre-recorded threshold value is substantially 1 MHz.

10. An apparatus for determining a position of an optical pick-up head emitting light on an optical disc in an optical disc drive, the optical disc comprising a pre-recorded region and a rewritable region, the apparatus comprising:
a detection circuit, detecting at least two wobble signals when the optical disc is rotated at a same speed, and obtaining a first parameter related to a first wobble signal and a second parameter related to a second wobble signal; and
a determination circuit, comparing the first parameter and the second parameter with a first pre-stored threshold value and a second pre-stored threshold value, if the first parameter is larger than the first pre-stored threshold value, then determining that the light beam is at the pre-recorded region, and if the first parameter is smaller than the first pre-stored threshold value and the second parameter is smaller than the second pre-stored threshold value, then determining that the light beam is at the rewritable region.

11. The apparatus of claim 10, wherein the first pre-stored threshold value is larger than the second pre-stored threshold value.

12. The apparatus of claim 10, wherein the pre-recorded region comprises a frequency modulation or a phase modulation.

13. The apparatus of claim 10, wherein the rewritable region comprises a minimum shift keying modulation.

14. The apparatus of claim 10, wherein the first parameter and the second parameter can be frequency, period, or pulse width of the wobble signal.

15. The apparatus of claim 14, wherein the frequency, period or pulse width of the wobble signal are averages of the frequency, period or pulse width of the wobble signal measured over a predetermined period of time.

16. The apparatus of claim 10 wherein the first parameter and the second parameter are detected at different locations of the track.

17. The apparatus of claim 10 wherein the first pre-stored threshold value and the second pre-stored threshold value are stored in memory.

18. The apparatus of claim 10 wherein when the optical disk rotates at 1× speed, the first pre-recorded threshold value is substantially 1.3 MHz, and the second pre-recorded threshold value is substantially 1 MHz.
